(19) United States
(12) Patent Application Publication
(10) Pub. No.: US 2012/0010777 A1
(43) Pub. Date: Jan. 12, 2012

(54) METHOD FOR LOCATING THE POSITION OF THE WHEELS OF A VEHICLE

(75) Inventor: Pierre-Yves Allard, Sambin (FR)

(73) Assignee: CONTINENTAL AUTOMOTIVE FRANCE, Toulouse (FR)

(21) Appl. No.: 13/256,049

(22) PCT Filed: Mar. 30, 2010
(86) PCT No.: PCT/EP2010/002012

§ 371 Date: Sep. 12, 2011

(30) Foreign Application Priority Data
Apr. 16, 2009 (FR) 09/01839

(51) Int. Cl. G06F 7/00

(52) U.S. Cl. 701/32.7

(57) ABSTRACT

A method for locating the position of wheels (4) fitted with an electronic module (8) suitable for transmitting, to a central processing unit mounted on the vehicle, signals representative of operating parameters of each wheel. During a given time window, the successive movements of the vehicle, changes of direction and/or changes of speed, are read so as to establish for each wheel (4), based on data stored in a preliminary phase, a series of values representative, for this succession of movements, of the theoretical variations of temperature inside the tire fitted to the wheel. Moreover, for each wheel (4), during the time window, the variations of the temperature inside the tire fitted to the wheel are measured, and the measured series of values is compared with each theoretical series of values, so as to establish a correspondence leading to the localization of the wheel.

The invention relates to a method for locating the position of wheels of a vehicle which are fitted with an electronic module suitable for transmitting, to a central processing unit mounted on the vehicle, signals representative of operating parameters of each wheel also comprising a code for identifying the latter.

More and more motor vehicles possess, for safety reasons, monitoring systems comprising sensors mounted on each of the wheels of the vehicle, dedicated to measuring parameters, such as pressure or temperature of the tires fitted to these wheels, and designed to inform the driver of any abnormal variation in the measured parameter.

These monitoring systems are conventionally furnished with an electronic module mounted on each of the wheels of the vehicle, incorporating, in addition to the aforementioned sensors, a microprocessor and a radiofrequency transmitter, and with a central processing unit for receiving the signals transmitted by the transmitters, comprising a computer incorporating a radiofrequency receiver.

One of the problems of such monitoring systems that requires resolution lies in the obligation of having to associate with each signal received by the receiver of the central processing unit an item of information relating to the localization of the electronic module and hence of the wheel that is the source of this signal, this obligation lasting throughout the life of the vehicle, that is to say having to be complied with even after wheel changes or more simply switchings of the position of these wheels.

Currently, a first localization method consists in incorporating an accelerometer in each electronic module, and in using a localization technique based on statistical methods consisting in comparing the accelerations of the various wheels in order to obtain an item of information on the respective position of each of said wheels.

This localization method is, however, not very effective because it requires notably a considerable running time in order to achieve a discrimination between the various wheels.

A second localization method consists in using three low-frequency antennas each positioned close to one of the wheels of the vehicle, and in carrying out a localization procedure consisting in successively exciting each of these three antennas by the transmission of a low-frequency magnetic field.

According to this procedure, the electronic module mounted on the wheel situated close to the excited antenna transmits, in response to and in the direction of the central processing unit, a low-frequency signal comprising an identification code of said module, so that the successive excitation of the three antennas leads to the localization of the three electronic modules mounted on the wheels next to these antennas, and by deduction, to the localization of the fourth module.

The main advantage of such a method lies in the fact that the localization procedure is very quick and leads to a virtually instantaneous localization after the vehicle is started.

However, this solution is very costly because it requires fitting the vehicle with three antennas with all the related constraints: connection cables, control amplifiers, etc.

A third localization method consists in determining the positioning of the wheels based on a comparison of the intensity of the signals received by the central processing unit from each transmitter. As notably described in patent EP 0 931 679, this method consists:
in a preliminary phase, in programming the central processing unit so as to generate, from the envelope of amplitude of the signal received from each transmitter, a signature of this signal, then in storing in said central processing unit each signature and the corresponding position of the wheel,
and, when the vehicle is in use, in applying a localization procedure consisting in generating in the central processing unit the signatures of the signals received from the transmitters, and in comparing each signature with the stored signatures so as to deduce therefrom the position of the corresponding wheel.

It turns out however that the envelope of amplitude of the signals received from each transmitter may be adversely affected depending on the road conditions, and notably be adversely affected by a wet road, in the presence of metal elements such as a safety rail, when running in a tunnel, etc. The result of this, in practice, is that this localization method may require considerable running times in order to carry out a discrimination between the various wheels.

The subject of the present invention is another method for locating the position of the wheels of a vehicle, and its main object is to provide a localization method that is very effective in terms of responsiveness and reliability, the use of which generates a very low overall cost price.

Accordingly, the subject of the invention is a method for locating wheels of a vehicle consisting:
in a preliminary phase, in measuring and in storing, for each position of wheel of the vehicle, the instantaneous variations of a parameter representative of the temperature inside the tire fitted to said wheel, resulting from the movements, changes of speed and/or changes of direction, of the vehicle,
and, during the use of the vehicle, in using a localization procedure consisting, during a time window of determined duration:
   in reading the successive movements of the vehicle, changes of direction and/or changes of speed, and in establishing for each wheel, based on these readings and on the stored data, a series of values representative, for this succession of movements, of the theoretical variations of the parameter representative of the temperature inside the tire fitted to said wheel,
   and, for each wheel, in measuring the variations of the parameter representative of the temperature inside the tire fitted to said wheel, and in comparing the measured series of values with each theoretical series of values, so as to establish a correspondence leading to the localization of the wheel.

The invention therefore consisted in revealing and exploiting the fact that, during each movement, change of speed and/or change of direction, of a vehicle, on the one hand the temperature inside each tire sustains an instantaneous variation, and on the other hand this temperature variation differs from one wheel position to the other wheel positions so that it is possible to establish data signifying the position of the wheels based on measurements of these temperature variations.

Such a technique is, in the first place, very effective in terms of responsiveness because it leads to obtaining a localization of the longitudinal position of the wheels after only a few movements of a vehicle, after the latter has been started.

Moreover, in order to apply this method, it requires only the presence of means suitable for ascertaining the successive movements of the vehicle, such means consisting either of receivers of satellite positioning systems, such as the GPS systems, or of sensors of electronic management systems, such as ABS systems or ESP systems. Such means are currently fitted to the majority of vehicles so that the use of the localization method according to the invention requires no specific equipment.

According to an advantageous embodiment of the invention, the pressure inside said tire is measured as a parameter representative of the temperature inside the tires. The pressure consists, in effect, of a conventionally measured and monitored parameter the value of which is directly proportional to the value of the temperature inside a tire, and the measured values of which correspond to the real instantaneous values of this parameter.

According to another advantageous embodiment of the invention designed to allow a coding compression of the data transmitted to the central processing unit, each electronic module is suitable for periodically transmitting, at moments t(i), series of values corresponding to the instantaneous value of the parameter representative of the temperature measured at the moment of transmission ti, and to the fluctuations, relative to this instantaneous value, of the measured values of this parameter during the period preceding this transmission.

Other features, objects and advantages of the invention will emerge from the following detailed description with reference to the appended drawings which represent as a nonlimiting example a preferred embodiment thereof.

In these drawings:

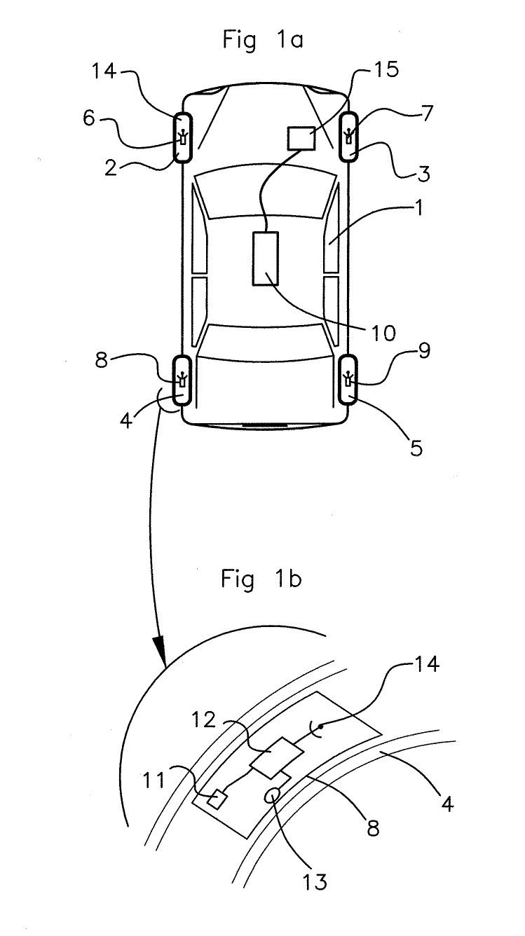

FIG. 1a is a schematic view from above of a vehicle furnished with a monitoring system capable of allowing the localization method according to the invention to be applied,

FIG. 1b is a detailed schematic view in perspective representing a portion of wheel of this vehicle and the electronic module fitted to the latter.

The vehicle 1 shown in FIG. 1a is furnished with four wheels conventionally fitted with a tire: two front wheels 2, 3 and two rear wheels 4, 5.

This vehicle 1 is fitted with a monitoring system conventionally comprising, in the first place, associated with each wheel 2-5, an electronic module 6-9, for example secured to the rim of said wheel so as to be positioned inside the envelope of the tire.

As shown in FIG. 1b, each of these electronic modules 6-9 incorporates, for example, sensors 11 dedicated to the measurement of parameters, such as pressure and temperature of the tire, connected to a computing unit 12 with microprocessor powered electrically by means of a button cell 13, and connected to an RF transmitter connected to a high-frequency antenna 14.

As shown in FIG. 1a, the monitoring system also comprises a centralized computer or central processing unit 10 situated in the vehicle 1, comprising a microprocessor and incorporating an RF receiver capable of receiving the signals transmitted by each of the four electronic modules 6-9.

Usually, such a monitoring system and notably its central processing unit 10 are designed so as to inform the driver of any abnormal variation in the parameters measured by the sensors 11 associated with the wheels 2-5.

Accordingly, the central processing unit 10 is notably programmed to make it possible to associate with each signal received by the latter an item of information concerning the position of the wheel 2-5 fitted with the electronic module 6-9 at the origin of this signal.

For the purpose of this localization, and in the first place according to the invention, the central processing unit 10 is connected to means suitable for ascertaining the successive movements of the vehicle 1, such means consisting either of receivers of satellite positioning systems 15, such as GPS systems, or of sensors of electronic management systems 15, such as ABS systems or ESP systems.

This localization also requires, according to the invention, the application of a preliminary phase, consisting in measuring and in storing, for each position of wheel 2-5 of the vehicle 1, the instantaneous variations of the pressure inside the tire fitted to said wheel, resulting from the movements, changes of speed and/or changes of direction, of the vehicle 1.

It should be noted that this preliminary phase can be carried out by learning or by simulations by means of a computer tool.

Moreover, this preliminary phase may be carried out, by learning or simulations, in an overall manner for all the vehicles of one and the same platform, and the corresponding data incorporated into the central processing unit 10 of all the vehicles 1 of this platform.

In this case, additionally, these data can then be refined during the first uses of the vehicle 1 and thus be adapted to the driving and journey habits of the driver. It should be noted that the stored data may also be subsequently refined in a regular manner and thus be continually adapted to the changes in driving of the vehicle 1.

As a variant, the preliminary phase may also consist of a learning phase carried out for each vehicle 1 during the first uses of the latter.

When this preliminary phase is completed, the invention consists, during the use of the vehicle 1, in using a localization procedure consisting, in the first place, in the central processing unit 10:
in reading, during a time window of determined duration T, by means of the system 15 connected to said central processing unit, the successive movements of the vehicle 1, changes of direction and/or changes of speed,
and in establishing for each wheel 2-5, based on these readings and on the data stored during the preliminary phase, a series of values representative, for this succession of movements, of the theoretical variations of the pressure inside the tire fitted to said wheel.

Moreover, this localization procedure consists, for each wheel 2-5, in measuring, for the same time window of duration T, the variations of the pressure inside the tire fitted to said wheel, and in transmitting the measured series of values to the central processing unit 10.

This localization procedure finally consists, for the central processing unit 10, in comparing, for each wheel 2-5, the measured series of values at said wheel with each theoretical series of values generated in said central processing unit, so as to establish a correspondence leading to the localization of the wheel.

Moreover, the duration T of each time window advantageously corresponds to the period of transmission by each electronic module 6-9 of the signals representative of the operating parameters of the corresponding wheel 2-5.

Moreover, each electronic module 6-9 is suitable for transmitting, at moments t(i) and with this period T, series of values corresponding, in the first place, to the instantaneous value of the pressure in the tire measured at the moment of transmission ti, and, in the second place, to the fluctuations, relative to this instantaneous value, of the measured values of the pressure during the period T.

The localization method according to the invention described above therefore makes it possible, without requiring any special equipment, to very rapidly and reliably locate the position of the wheels 2-5 of a vehicle 1.

1. A method for locating the position of wheels (2-5) of a vehicle (1) which are fitted with an electronic module (6-9) suitable for transmitting, to a central processing unit (10) mounted on the vehicle (1), signals representative of operating parameters of each wheel also comprising a code for identifying the latter, said localization method comprising:
in a preliminary phase, measuring and storing, for each position of wheel (2-5) of the vehicle (1), the instantaneous variations of a parameter representative of the temperature inside the tire fitted to said wheel, resulting from the movements, changes of speed and/or changes of direction, of the vehicle (1), and,
during the use of the vehicle (1), using a localization procedure comprising, during a time window of determined duration:
reading the successive movements of the vehicle (1), changes of direction and/or changes of speed, and establishing for each wheel (2-5), based on these readings and on the stored data, a series of values representative, for this succession of movements, of the theoretical variations of the parameter representative of the temperature inside the tire fitted to said wheel,
and, for each wheel (2-5), measuring the variations of the parameter representative of the temperature inside the tire fitted to said wheel, and comparing the measured series of values with each theoretical series of values, so as to establish a correspondence leading to the localization of the wheel.

2. The localization method as claimed in claim 1, wherein the pressure inside said tire is measured as a parameter representative of the temperature inside the tires.

3. The localization method as claimed in claim 1, wherein each electronic module (6-9) is suitable for periodically transmitting, at moments t(i), series of values corresponding to the instantaneous value of the parameter representative of the temperature measured at the moment of transmission ti, and to the fluctuations, relative to this instantaneous value, of the measured values of this parameter during the period preceding this transmission.

4. The localization method as claimed in claim 2, wherein each electronic module (6-9) is suitable for periodically transmitting, at moments t(i), series of values corresponding to the instantaneous value of the parameter representative of the temperature measured at the moment of transmission ti, and to the fluctuations, relative to this instantaneous value, of the measured values of this parameter during the period preceding this transmission.
